(19) United States
(12) Patent Application Publication
(10) Pub. No.: US 2015/0181039 A1
(43) Pub. Date: Jun. 25, 2015

(54) ESCALATION DETECTION AND MONITORING

(71) Applicant: AVAYA, INC., BASKING RIDGE, NJ (US)

(72) Inventors: George Erhart, Loveland, CO (US); Valentine C. Matula, Granville, OH (US); David Skiba, Golden, CO (US)

(73) Assignee: AVAYA, INC., BASKING RIDGE, NJ (US)

(21) Appl. No.: 14/134,533

(22) Filed: Dec. 19, 2013

(51) Int. Cl. H04M 3/51; H04M 3/523

(52) U.S. Cl. CPC H04M 3/5191; H04M 3/5232

(57) ABSTRACT

Communications in a contact center may utilize one of a number of communications channels. Certain channels may operate at a lower cost or fewer resources while another channel is more secure and/or faster or otherwise better suited for a particular communication. A communication between an agent of a contact center and a customer may initially be on a first channel but during the communication a content indicator that the channel is inappropriate or less desirable than a second channel. Once such an event occurs, the communication on the first channel may be terminated and moved to a second communication channel.

### FIELD OF THE DISCLOSURE

The present disclosure is generally directed toward contact center operations and more particularly to the communication channel used by the contact center to communicate with a customer.

### BACKGROUND

Contact centers today are realizing many challenges as communications from customers come in from multiple channels. In the past, the communications typically would come in to a contact center via voice call and/or email. Rules for engagement for both of these channels have been well-established.

With the advent of, and easy accessibility to, additional channel types including text, video, chat, web including social media sites, Automated Teller Machines (ATMs), self-service kiosks, Interactive Voice Response (IVR) units, and speech recognition, rules for engagement are less established.

Privacy is one area that must be seriously considered in developing practices for contact centers. A customer communicating on a company's social media page may need to provide account information to an agent of the company. The account information should not be publicly available. Accordingly, the sharing of private information on a public social media website should be avoided.

### SUMMARY

It is with respect to the above issues and other problems that the embodiments presented herein were contemplated.

In one embodiment, a predictive mechanism to detect when escalation and/or de-escalation of any mode of communication should be promoted to a voice or voice/video channel and to provide notifications based on content as to when a communication should be moved to a different channel (e.g., direct message, voice, voice/video). In another embodiment, as progress on an issue begins to stall or instructions/communications may be misunderstood, such as during certain types of written communication, it may be a more expedient course of action to change channels, like escalation to a voice call to provide clarity not previously available over the original channel being used.

A system operable to predict an appropriate media escalation can assist agents in making decisions regarding channel changing functionally similar to multi-topic resource allocation. The system can observe, in real-time or near-real-time, a communication session in progress and predict or determine when a change in channel should occur. The system can monitor incoming communications from the customer, outgoing agent responses, and the conversation stream during real-time or near real-time interactions.

A media channel change can go either direction. For example, the channel could be downgraded or de-escalated from voice to email. However, the downgrade may be less common than the escalation of the channel. A more common prediction would be an escalation, like moving from a social media channel to chat session to voice session or co-browsing with chat or voice. Each of the channel changes can have time and related cost factors, which can be accounted for by the system.

For example, an agent might be able to conclude a communication faster using a telephone call if an email exchange has stalled or the user doesn't understand directions that the agent has provided. The stall could be indicated by hitting a time threshold between communications, detection of keywords and phrases, or manual input by the agent. Progress could also be determined based on a scripted vs. an unscripted path. If the agent or the system determines or predicts that the issue can be concluded faster using another channel, the change of channel should be suggested to the agent or made automatically by the system. The agent could be alerted and/or given a prompt to initiate a voice call to wrap up the session. A rules engine can be used to set parameters for determining when a channel should go private and when it may be appropriate to be non-private (e.g., public).

The system could monitor communications in progress and make channel changes, suggestions, or provide alerts based on:

1. Topic switch—topic public to private (security); call is delayed, “what about my upgrade?”

2. Modality switch—topic progress or topic needs additional media or needs to get resolved faster/passes a threshold.

3. Accidental direct message—Agent says, “Give me your account information,” and the system alerts the agent to establish a private channel or escalates automatically to a private modality; Inappropriate requests for information—Agent requests an account number, and the system automatically alerts the agent to change channels and blocks a public post until the channel is secure. Publicly available information like the name of a city or a problem others may be experiencing could remain public.

4. Customer-provided information—If a customer sends information that should be private, the system could block or in some cases delete a message and put it on a private channel and, optionally, save a copy for later use on the private channel. For example, a customer says, “here is my account number/order number and the bill was too much.”

In some embodiments, a notification to a supervisor could be automatically generated if an agent ignores an escalation alert or refutes an attempt by the system to escalate.

In some embodiments, the system may provide automatic actions or suggestions to the agent for switching channels, allocating channels, and stepping through the dialog to perform the switch.

In one embodiment, a method is disclosed, comprising: determining that a first communications channel has been established between a customer and an agent of a contact center; monitoring content of information exchanged between the customer and the agent over the first communications channel for an occurrence of a predetermined content associated with a second communication channel and not associated with the first communications channel; and upon detecting the occurrence of the predetermined content within the first communication channel, notifying the agent of the occurrence of the predetermined content.

In another embodiment, a system is disclosed, comprising: an agent communication device; a channel monitoring and notification module; and a communication interface operable to facilitate communications between the agent communication device and a customer communication device; and wherein the channel monitoring and notification module is operable execute instructions to monitor content of information exchanged between the customer communication device and the agent communication device on the first communications channel for an occurrence of a predetermined content associated with a second communication channel and not associated with the first communications channel, and upon detecting the occurrence of the predetermined content within the first communication channel, notifying the agent of the occurrence of the predetermined content.

In yet another embodiment, a non-transitory computer readable medium is disclosed with instructions thereon that when read by the computer cause the computer to perform: determining that a first communications channel has been established between a customer and an agent of a contact center; monitoring content of information exchanged between the customer and the agent over the first communications channel for an occurrence of a predetermined content associated with a second communication channel and not associated with the first communications channel; and upon detecting the occurrence of the predetermined content within the first communication channel, notifying the agent of the occurrence of the predetermined content.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a first communications system in accordance with embodiments of the present disclosure;

FIG. 2 depicts a second communications system in accordance with embodiments of the present disclosure; and

FIG. 3 depicts a process in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

The identification in the description of element numbers without a subelement identifier, when a subelement identifiers exist in the figures, when used in the plural, is intended to reference any two or more elements with a like element number. A similar usage in the singular, is intended to reference any one of the elements with the like element number. Any explicit usage to the contrary or further qualification shall take precedent.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

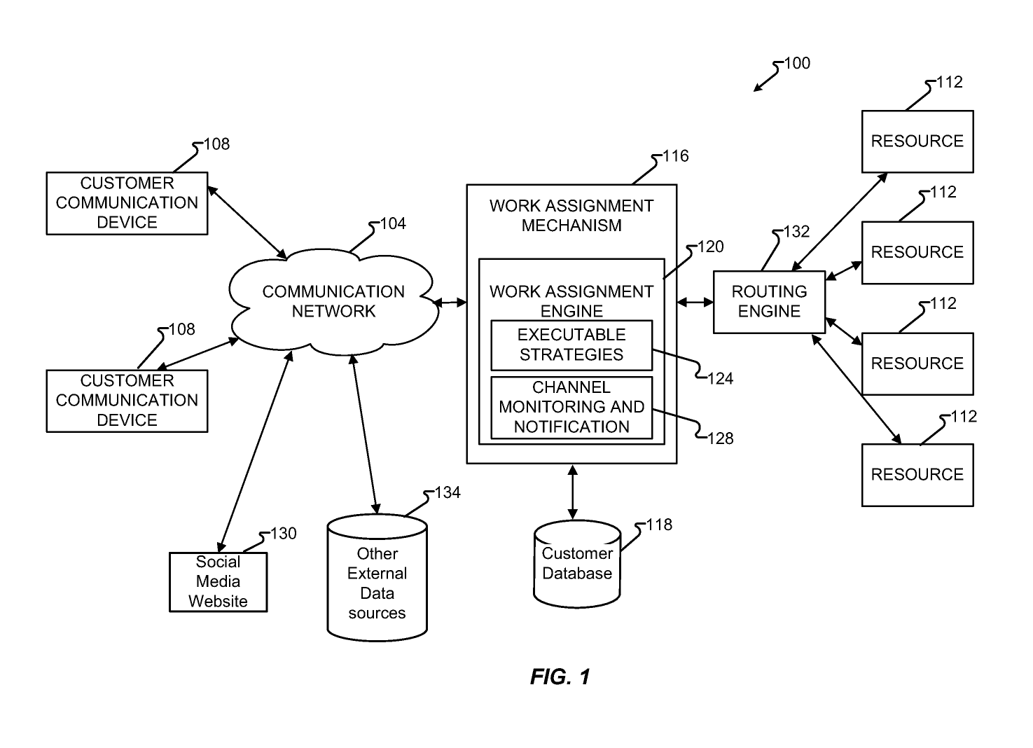

FIG. 1 shows an illustrative embodiment of a communication system 100 in accordance with at least some embodiments of the present disclosure. Communication system 100 may be a distributed system and, in some embodiments, comprises communication network 104 connecting one or more communication devices 108 to a work assignment mechanism 116, which may be owned and operated by an enterprise administering a contact center in which a plurality of resources 112 are distributed to handle incoming work items (in the form of contacts) from customer communication devices 108.

In accordance with at least some embodiments of the present disclosure, communication network 104 may comprise any type of known communication medium or collection of communication media and may use any type of protocols to transport messages between endpoints. Communication network 104 may include wired and/or wireless communication technologies. The Internet is an example of communication network 104 that constitutes and Internet Protocol (IP) network consisting of many computers, computing networks, and other communication devices located all over the world, which are connected through many telephone systems and other means. Other examples of communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, communication network 104 may comprise a number of different communication media such as coaxial cable, copper cable/wire, fiber-optic cable, antennas for transmitting/receiving wireless messages, and combinations thereof.

Communication devices 108 may correspond to customer communication devices. In accordance with at least some embodiments of the present disclosure, a customer may utilize their communication device 108 to initiate a work item, which is generally a request for a processing resource 112. Illustrative work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in communication network 104 where it is harvested by work assignment mechanism 116, which generates a work item for the harvested communication. An example of such a harvested communication includes a social media communication that is harvested by work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The format of the work item may depend upon the capabilities of communication device 108 and the format of the communication. In particular, work items are logical representations within a contact center of work to be performed in connection with servicing a communication received at the contact center (and more specifically work assignment mechanism 116). The communication may be received and maintained at work assignment mechanism 116, a switch or server connected to work assignment mechanism 116, or the like until a resource 112 is assigned to the work item representing that communication at which point work assignment mechanism 116 passes the work item to routing engine 132 to connect communication device 108 which initiated the communication with the assigned resource 112.

Although the routing engine 132 is depicted as being separate from work assignment mechanism 116, routing engine 132 may be incorporated into work assignment mechanism 116 or its functionality may be executed by work assignment engine 120.

In accordance with at least some embodiments of the present disclosure, communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center.

More specifically, the work assignment engine 120 comprises executable strategies 124 that, when executed, enable the work assignment engine 120 to determine which of the plurality of processing resources 112 is qualified and/or eligible to receive the work item and further determine which of the plurality of processing resources 112 is best suited to handle the processing needs of the work item. In situations of work item surplus, the work assignment engine 120 can also make the opposite determination (i.e., determine optimal assignment of a work item resource to a resource). In some embodiments, the work assignment engine 120 is configured to achieve true one-to-one matching by utilizing bitmaps/tables and other data structures.

In accordance with at least some embodiments of the present disclosure, the work assignment engine 120 may be configured to execute one or several executable strategies 124 to make work assignment decisions. As will be discussed in further detail herein, the work assignment engine 120 may comprise a plurality of executable strategies 124, where one or more of the executable strategies 124 include one or many tasks that are performed by the work assignment engine 120 during execution of the executable strategy 124. The order or manner in which the tasks of a strategy 124 are executed by the work assignment engine 120 may be defined by rules or policies, which may also be included in the executable strategy 120. Non-limiting examples of tasks that can be included in an executable strategy 124 include, without limitation, any of the following actions:

For a Resource: Add, Remove, Change a State (e.g., READY, ON DUTY, NOT READY, etc.), Update, Enable, Disable, Qualify Resource, Qualify Match, Score Resource, Begin, Finish, Set New Best, Enqueue, Dequeue, Accept, Reject, and Timeout

For a Work Item: Add, Remove, Update, Cancel, Begin, Finish, Next Evaluation, Find Resource, Qualify Work, Qualify Match, Score Work, Set New Best, Enqueue, Dequeue, Accept, Reject, Requeue, Ready, Not-Ready, Complete, and Time-Out

For a Service: Add, Remove, Update, and Enable

For Determining a Best Match: Assign Work To Resource, and Determine Well-Matched

For Determining Context: Heartbeat Failure, Customer Score, Custom Qualify, Custom Well Matched, Ready Res Service Capabilities, Not Ready Res Service Capabilities, Begin Resume, Begin Service Enable, Metric Sample, Intrinsic Sample, Intrinsic Sample All, Compute Requeue Metrics, Compute Enqueue Metrics, Compute Dequeue Metrics, Add Existing, Completed, Compute Rejected Metrics, Compute Accepted Metrics, Accepted, Rejected, Requeued, Compute Abandoned Metrics, and Compute Completed Metrics

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

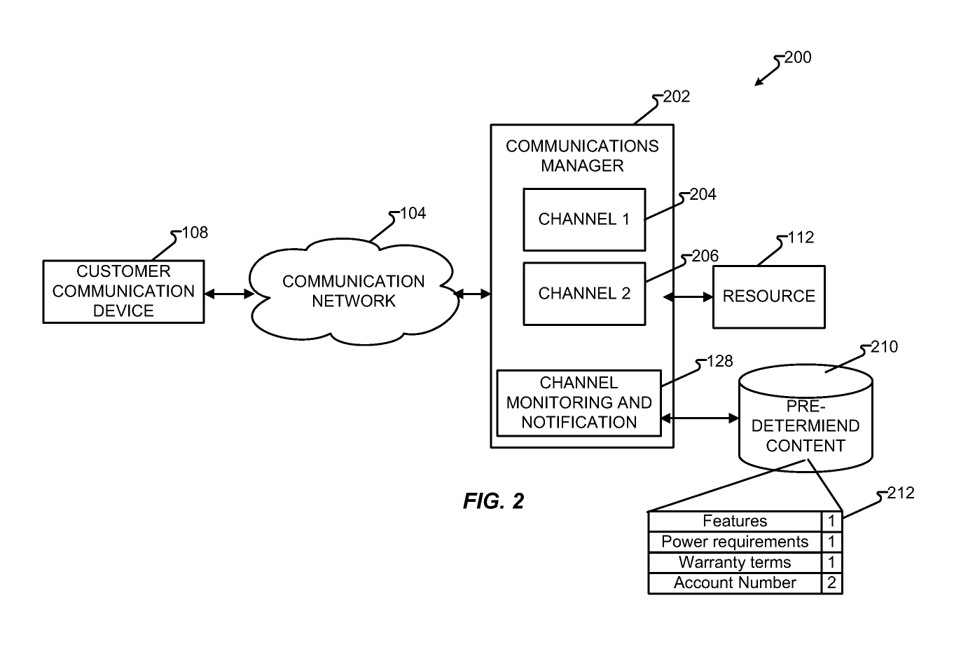

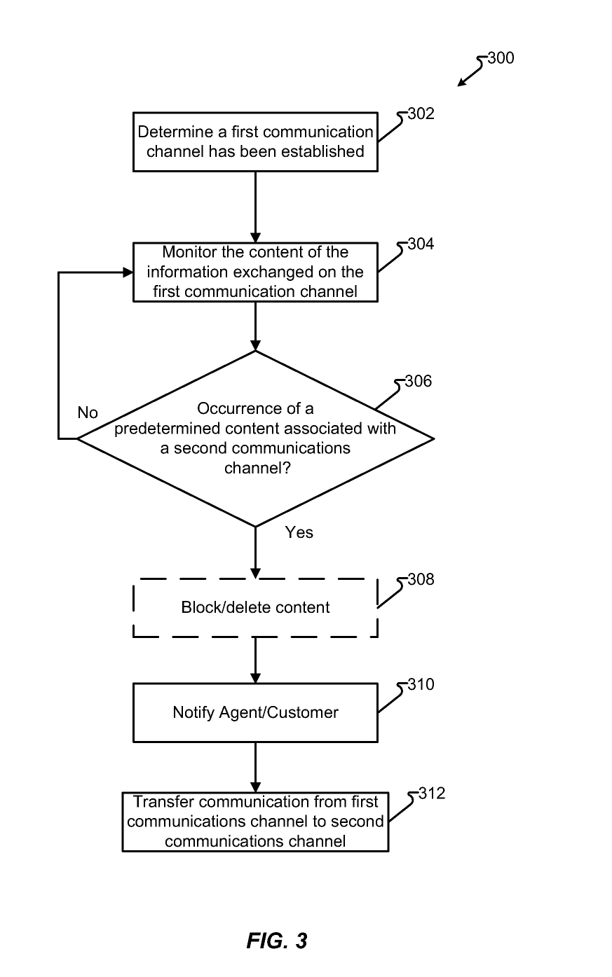

In one embodiment, a message is generated by customer communication device 108 and received, via communication network 104, at work assignment mechanism 116. The message received by a contact center, such as at the work assignment mechanism 116, is generally, and herein, referred to as a “contact.” Routing engine 132 routes the contact to at least one of resources 112 for processing via a communications channel. As will be described more fully with respect to FIGS. 2 and 3, the communication channel may be inappropriate and/or less desirable than another communications channel.

In another embodiment, some embodiments described herein may be implemented in channel monitoring and notification module 128. Channel monitoring and notification module 128 provides services whereby traffic on channels may be monitored and notifications sent to one or more resources 112 and/or customer communication device 108, such as when a channel change should or must be performed and/or when a particular channel message has been blocked and/or deleted.

With reference now to FIG. 2, a second communications system 200 will be described for monitoring communications in accordance with embodiments of the present disclosure. In one embodiment, communications manager 202 provides a connection between one or more resources 112 and the communication network 104, thereby enabling communications between the resource 112 and customer communication device 108. Communications manager 202 may be integrated into routing engine 132, work assignment mechanism 116, another component or as a discrete device or component. Communication manager is shown as having channel 1 (204) and channel 2 (206) and monitored by channel monitoring and notification module 128. Channel monitoring and notification module 128 may be executed on a stand-alone processor and/or a shared processor.

In one embodiment, communication is established between customer communication device 108 and resource 112 utilizing channel 1 (204). Channel monitoring and notification module 128 monitors the content of the information exchanged. Channel monitoring and notification module 128 compares the content to entries in predetermined content 210. Predetermined content 210 may be a database, table in a database, memory entry, register entry, and/or other repository of information accessible to channel monitoring and notification module 128. In a further embodiment, predetermined content 210 may be individual words, phrases, patterns, expressions, and/or algorithms whereby appropriateness for a particular channel may be determined.

For example, table 212 illustrates one set of predetermined content. Words and phrases, such as “features,” “power requirements,” and “warranty terms” are associated with channel 1 (204) whereas the phrase “account number” is associated with channel 2 (206). In the course of the communication utilizing channel 1 (204) if the phrase, “account number” is detected, with its association with channel 2 (206), a transition from channel 1 (204) to channel 2 (206) is initiated. Such may be expected when a private datum (e.g., “account number”) is or is reasonably expected to be communicated on a public channel, such as when channel 1 (204) is publicly accessible whereas channel 2 (206) is private.

In a further embodiment, if a communication is utilizing channel 2 (206) and the phrase “account number” never occurs, or has not occurred for a previously determined length of time, but words such as “features,” “power requirements,” and “warranty terms” do occur, channel monitoring and notification module 128 may cause or suggest transferring the communication to channel 1 (204). Such may be expected when the cost or other resource requirements of channel 2 (206) are higher than those of channel 1 (204). As can be appreciated, words or phrases may have no entry in predetermined content 210 as may be the case when words, including phrases, patterns, etc. have no association with a particular channel. For example, an exchange involving “small talk” between a customer and an agent may comprise no entries in predetermined content 210 and, therefore, indicate the status quo where the current one of channel 1 (204) or channel 2 (206) is continued to be utilized.

A pattern may be determined by a single communication, for example, “###-##-####” where “#” represents a digit, is a pattern associated with a U.S. Social Security number and, therefore, may indicate private information and a need to use, or continue to use, a secure channel. In another embodiment, a pattern is determined by a number of communications. For example, a customer may be seeking some general information, then want to known about costs, payment terms, or other sales related information. The pattern may indicate that the customer may want to make a purchase and be directed to continue the communication on a sales channel. As a further embodiment, complex information may be exchanged and a customer may show signs of impatience, confusion, frustration, and so on. Accordingly, the pattern may indicate a need to switch to a voice and/or video channel whereby complex information may be more clearly communicated. A customer may participate in a communication exchange comprising a number of communications whereby the resolution will likely require the agent to obtain private information. For example, “Do you normally charge an annual fee on your alpha-level credit card?” “Would the annual fee show as being billed from The Bahamas?” may be general, non-private questions but the pattern may indicate that the customer will need a secure channel to provide a credit card number so that a specific charge may be investigated by the agent.

In another embodiment, the intent, sentiment (e.g., positive, negative, neutral, etc.), customer history, customer attribute (e.g., “platinum level,” known non-English speaker, known high level of subject matter expertise, angers easily, etc.), or other aspect may be determined and associated with a particular channel or channels by an entry in predetermined content 210. For example, a text-based channel may be acceptable for most customers but a customer who has difficulty understanding instructions may be better served if they are quickly moved to a channel, such as voice or video, where complex instructions may be more easily conveyed. Therefore, one entry in predetermined content 210 table 212 may be, “simple content—1”, and another entry may be, “comprehension difficulty—2.” As a further embodiment, a rule may be implemented to resolve any conflicts. Such as, any indicator (e.g., customer attribute, word, pattern, etc.) than indicates channel 2, shall take precedent over any indicator of channel 1. The specific rule may be a matter of design choice to follow the policy of the contact center or other entity.

Channels are variously embodied and comprise various attributes. In one embodiment, a channel may be defined by privacy (e.g., public, private, encrypted, etc.). In another embodiment, a channel may be defined by the medium (e.g., email, voice, telephony, text chat, video chat, co-browse, posting on a social media website, etc.). In yet another embodiment, a channel may be defined by operational requirements of the contact center (e.g., lower cost/higher cost, human/automated, faster response/slower response, greater resource requirements/lower resource requirements, agent with a first attribute/agent with a second attribute, etc.). Channels may be defined by a combination of features, for example, sales information may be associated with privacy (e.g., higher security for the transfer of credit card information) and medium (e.g., voice and telephony). The selection of attributes to define a channel may be a matter of design choice. For example, one enterprise may consider account numbers to be highly confidential and warrant the utilization of channels having a high level of security. Whereas another enterprise may consider account numbers to be of no consequence and associated with a channel having a low level of security or, alternatively, to not be a predetermined content 210 entry and therefore not indicate any channel or otherwise be appropriate for any channel.

The establishment of predetermined content 210 having entries associated with channels may then reflect the attribute of the channel. For example, content that should be private (e.g., account numbers, social security numbers, etc.) may be associated with one or more channels having a greater degree of security. Similarly agent attributes may determine a channel. Complex or easily misunderstood content may be associated with channels having a greater ease or accuracy in providing complex information. In another example, certain agents may be qualified to answer only general questions about products or services and other general information while other agents may be qualified to answer more specific questions and make sales. Therefore, one channel may be defined by agents with a first skill (e.g., general information) while another channel may then be associated with agents with a second skill (e.g., technical experts, sales, etc.). The channel may further be associated with security (e.g., sales requires a more secure channel to safely transfer credit card information) and/or other attribute as may be appropriate.

With reference now to FIG. 3, a process 300 will be described in accordance with embodiments of the present disclosure. In one embodiment, process 300 determines that a first communication channel has been established, such as between resource 112 and customer communication device 108. Step 304 monitors the content of the information exchanged. Monitoring step 304 may be performed by channel monitoring and notification module 128 executing monitoring instructions.

Step 306 determines if a predetermined content associated with a second communications channel has occurred on the first communications channel. In one embodiment, channel monitoring and notification module 128 compares words, phrases, sentiment, subject matter, customer attributes, patters, etc. to entries in a repository, such as predetermined content 210 and determines if the content is associated with the second communications channel. If no, process continues back to step 304, if yes, processing continues to optional step 308 or, if step 308 is not implemented, to step 310.

In one embodiment, step 308 blocks the content on the first channel. In one embodiment, the second channel is associated with agents with a security to receive personal information (e.g., medical information, account numbers, etc.) whereas agents associated with the first channel do not have the required security. During a voice call, the customer, utilizing customer communication device 108 embodied to convey voice information, offers their account information and step 308 mutes the customers voice such that the agent does not hear the account. In another embodiment, the agent asks for personal information and the agent's voice is muted. As a further option, a live or recorded message may be delivered to one or more of the customer and agent, such as by step 310, notifying one or both parties as to why the line was muted.

In another embodiment, such as when the first communication channel is a social media website, step 308 blocks the posting of information deemed confidential. Not all social media websites may be operable to support such functionality, however, certain social media website may be controlled or controllable by the contact center and if confidential information is about to be posted on a first channel associated with postings publically visible, the posting may be blocked. Similarly, a posting may be deleted if blocking is not performed. Similarly, a first communication channel associated with email may block the sending of emails, such as the emails created by the agent, or automatically delete incoming emails received by the customer. Optionally, the deleted emails are securely saved and made available on the second communication channel, designated for secure communications.

Step 310 notifies the agent and/or the customer of the occurrence of the predetermined content associated with a second communications channel. The notification is variously embodied, such as the recorded message, described above, that may be presented when an agent asks or a customer offers secure information that requires an agent with security clearance. When the first channel is a text message, email, text chat or similar text-based communications medium, a preformatted text message (e.g., pop-up dialog, SMS, email, etc.) may be inserted to the agent, such as, “Texting/emailing sales terms is not permitted. Ask customer to if you can call them to discuss sales details.” The customer may agree or refuse. If they agree, the communication is transferred to a voice channel. If they refuse, step 308 may continue to block/delete sales details from the text-based channel but allow other, non-confidential, communication to continue. In another embodiment, a contact center controlled social media website may provide a pop-up window to perform step 310. For example, “This forum is used for general questions and tips. You appear to have attempted to post your account number, which is considered confidential. The posting has been blocked. Please click <here> to be connected to an agent who can answer questions regarding your account.”

Step 310 may be omitted in certain situations. For example, a work assignment mechanism 116 may provide emails to a resource 112 to address a general question. An exchange between resource 112 and the customer may continue to be routed by routing engine 132 and/or work assignment mechanism 116 to the same agent. However, if the conversation is determined to have changed, or is about to change, a new resource 112 may be selected and future emails directed towards that particular resource 112. The prior agent and customer do not need to be specifically notified that a new agent is being assigned, the communication continues between the customer and the new resource 112. However, in many embodiments, the transfer of the communication from a first channel to a second channel is noticeable to the customer or otherwise disruptive and may require notification so that the disruption may be expected and the impact minimized.

While conversations may more commonly start out as general and become more specific (e.g., require a channel supporting detailed communications), more secure (e.g., require a channel supporting greater security), or otherwise require greater resources, the opposite may also occur. In one embodiment, step 302 establishes a communications channel between a customer communication device 108 and resource 112. The channel initially utilized, the first channel, is associated with technical experts who can offer expedited responses. The resources associated with the first channel are more resource intensive. Step 306 determines the content of the communication is associated with a second communications channel. For example, the content associated with the first channel may include, “emergency,” “outage,” “urgent,” “restart procedure,” and so on. However, if the content of the communication is more general (e.g., “what products would work with my model XYZ?” “What colors does it come in?” “I found a useful tip that I′d like to share,” etc.), then the second communication, such as a publicly accessible social media website, or a non-real-time channel (e.g., email), may be selected to be more resource efficient. Accordingly step 308 may be omitted and step 310 notifies the agent and/or customer of a website and/or email where they can ask/provide the more general information. Step 312 may then automatically, transfer the communication to a less resource intensive channel. Such as emails being automatically posted to a social media page or routed to agents providing general information.

The embodiments herein are generally directed towards a first and second channel, such as channel 1 (204) and channel 2 (206). However, it should be apparent to those of ordinary skill in the art that any number of channels, greater than one, may be implemented whereby the channels are distinguishable by an attribute associated with corresponding predetermined content. For example, a particular entry in predetermined content 210 may be associated with a text channel, a secure channel, a voice channel, a video channel, an agent with expert technical knowledge, an IVR, an automated agent, or other one or more attributes.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

1. A method, comprising:
determining that a first communications channel has been established between a customer and an agent of a contact center;
monitoring content of information exchanged between the customer and the agent over the first communications channel for an occurrence of a predetermined content associated with a second communications channel and not associated with the first communications channel; and
upon detecting the occurrence of the predetermined content within the first communications channel, notifying the agent of the occurrence of the predetermined content.

2. The method of claim 1, wherein the first communications channel is terminated upon detecting the occurrence of the predetermined content.

3. The method of claim 1, further comprising, establishing the second communications channel and signaling the agent of the established second communications channel.

4. The method of claim 3, wherein the second communications channel is automatically established without receiving input from the agent, the method further comprising, delaying at least one of the establishing of the second communications channel and the terminating of the first communications channel until the agent responds to the notification.

5. The method of claim 1, wherein the predetermined content is a private datum and the first communications channel is less secure than the second communications channel.

6. The method of claim 5, further comprising, blocking the private datum from the first communications channel.

7. The method of claim 5, further comprising, automatically deleting the private datum from the first communications channel.

8. The method of claim 1, wherein the predetermined content is a private datum request and the first communications channel is less secure than the second communications channel.

9. The method of claim 1, wherein the predetermined content is a public datum and the first communications channel is more resource intensive than the second communications channel.

10. The method of claim 1, wherein the predetermined content is an expedited handling requirement and the first communications channel is less responsive than the second communications channel.

11. The method of claim 1, wherein the first channel is a text-based communications channel and the predetermined content is at least one word, of a text message of the information exchanged between the customer and the agent, matching a previously defined pattern.

12. The method of claim 1, wherein the predetermined content is at least one of a sentiment, intent, subject, and customer attribute.

13. A system, comprising:
an agent communication device;
a channel monitoring and notification module; and
a communication interface operable to facilitate communications between the agent communication device and a customer communication device; and
wherein the channel monitoring and notification module is operable to execute instructions to monitor content of information exchanged between the customer communication device and the agent communication device on the first communications channel for an occurrence of a predetermined content associated with a second communications channel and not associated with the first communications channel, and upon detecting the occurrence of the predetermined content within the first communications channel, notifying the agent of the occurrence of the predetermined content.

14. The system of claim 13, wherein the communication interface is operable to automatically establish the second communications channel between the agent communication device and the customer communication device without a signal from the agent communication device.

15. The system of claim 14, wherein the communications interface is further operable to terminate the first communications channel upon the establishment of the second communications channel.

16. The system of claim 13, further comprising:
a database accessible by the channel monitoring and notification module operable to store the predetermined content and associated at least one of the first communications channel and the second communications channel.

17. A non-transitory computer-readable medium with instructions thereon that when read by the computer cause the computer to perform:
determining that a first communications channel has been established between a customer and an agent of a contact center;
monitoring content of information exchanged between the customer and the agent over the first communications channel for an occurrence of a predetermined content associated with a second communications channel and not associated with the first communications channel; and
upon detecting the occurrence of the predetermined content within the first communications channel, notifying the agent of the occurrence of the predetermined content.

18. The medium of claim 17, further comprising instructions to terminate the first communications channel upon detecting the occurrence of the predetermined content.

19. The medium of claim 17, further comprising instructions to establish the second communications channel and signaling the agent of the established second communications channel.

20. The medium of claim 17, wherein the predetermined content is an expedited handling requirement and the first communications channel is less responsive than the second communications channel.
